(19) United States
(12) Patent Application Publication
(10) Pub. No.: US 2002/0186237 A1
(43) Pub. Date: Dec. 12, 2002

(54) Method and system for displaying analytics about a website and its contents

(76) Inventors: Michael Bradley, Ottawa (CA); Shannon Ryan, Ottawa (CA); Randy Woods, Chelsea (CA)

Correspondence Address: Dinesh Agarwal, Esquire, Law Office - Dinesh Agarwal , P.C., Suite 330, 5350 Shawnee Road, Alexandria, VA, 22312, US

(21) Appl. No.: 09/855,560

(22) Filed: May 16, 2001

(51) Int. Cl. G06F 3/00; G06F 15/173

(52) U.S. Cl. 345/736; 709/224

(57) ABSTRACT

There is provided a method of displaying analytics about a website And its contents resident on a server computer. The method comprises the steps of: (a) causing a browser program to be opened on the server computer with a first display frame and a second display frame immediately adjacent said first display frame, wherein the first display frame comprises a page of the website; (b) marking the page displayed in the first display frame with a first identifier and creating an interface call to a report server; (c) retrieving a report file corresponding to the first identifier from the report server; (d) displaying the analytics in the report file in the second display frame; (e) after a pre-determined period of time, comparing the page displayed in the first display frame with the first identifier; and (f) if different, repeating the method from step (b) for the page displayed in the first display frame; or (g) if the same, resetting for a second of the pre-determined period of time and repeating the method from step (e).

### FIELD OF THE INVENTION

This invention relates to a method and system for displaying analytics about a website and its contents in a manner which is effective and informative for the website operator.

### BACKGROUND OF THE INVENTION

The Internet and world wide web have become increasingly important in the world of commerce. For many businesses, their web site, a hyperlinked page that forms part of the world wide web, has become an important means for reaching the public.

Increasingly, businesses with a presence on the world wide web are in need of reporting and analytics that produce statistics and analysis of traffic levels at their web site, site usage and business performance of their website. The metrics produced may vary to suit the needs of the individual business. These can range from generic measures for the website, such as the overall level of site traffic in which case the metric would be simply “number of visits”. On the opposite end of the spectrum are page-specific measures such as number of page views, or “looks”. As well, measures vary according to the business model in question. Relevant metrics for e-commerce sites include measures such as revenue for individual products, while content sites may concentrate on measures such as ad revenue per content subsection, or time spent on a given content subsection, to assess the relative merit of that subsection and the content.

The problem for many businesses revolves around the sheer enormity of the web sites. It is not unusual for companies selling products over the Internet to have millions of individual products (or SKUs for “stock keeping units”), each with its own web page within the website, partitioned into thousands of categories and subcategories. Similarly, content based websites, such as newspapers and magazines, may contain hundreds of thousands of individual articles divided into hundreds or thousands of sections and subsections.

The resulting challenge for reporting products involves how to present a report that addresses a range of granularity, from high level site summary information down through various layers of aggregation to individual page level data, in a manner that is in some way intuitive and effective. The challenge is inherently similar to the problem faced by web site designers. Web site designers must present potentially millions of web pages to users in a manner that is easily navigable or consumable by the site visitor. In much the same manner, designers of reporting products for that web site must present potentially millions of reports (one per page) in a manner that is easily navigable by the report consumer.

Traditional web reporting consists of reports containing long lists of page identifiers alongside whatever metrics are tracked. An example is the table below

| | Number of | | Associated | Visit-to-look |
|---|---|---|---|---|
| Page address within web site (URL) | visits | Time at Page | revenue | ratio |
| /home | 932642 | 0:23 | $4,789,123.00 | 89% |
| /home/videos | 72774 | 0:12 | $456,243.00 | 12% |
| /home/videos/westerns/ID783743 | 344 | 0:54 | $54,723.95 | 0.86% |
| /home/books/mystery/ID739547aa73 | 843 | 0:34 | $67,328.05 | 0.34% |
| /home/videos/preowned/ID527465 | 353 | 0:35 | $12,390.00 | 0.23% |
| /home/books/action/ID7983743 | 552 | 0:59 | $34,873.55 | 1.01% |

This approach to report presentation becomes unwieldy when the number of pages on a website exceeds a few dozen. Many websites today have hundreds of thousands, if not millions of pages. Obviously no report is going to contain a single list of millions of products or corresponding page names or addresses. Typically, reporting products tend to make use of search engines of some sort. For instance, a report user at an e-commerce site may type in the SKU number of a product to get relevant information about that product. A content site report user may type in a page title or a page uniform resource locator (“URL”) (as in the example above) in order to get relevant information for that page.

The inherent limitation is that in either case the user is forced to recall either the title of a web page, its URL, or a product SKU number in order to get information. This is particularly problematic when the user is forced to recall what is essentially a name or ID from a list of millions. The report organization does not in any way reflect the organization of the underlying data being analyzed that is familiar to the user, namely that presented by the web site itself. The user typically already has a mental model of the organization of the data, one that has been developed and reinforced through navigation of his or her own web site. Traditional approaches to report presentation do not exploit this model.

### SUMMARY OF THE INVENTION

It is thus an object of the present invention to provide a method and software product to enable the website or business owner with an effective and intuitive way to review the desired analytics about a particular website, or its contents, and the pages which comprise the website, utilizing the layout and design of the web site itself.

In one aspect of the invention, there is thus provided a method of displaying analytics about a website resident on a server computer. The method comprises the steps of:

(a) causing a browser program to be opened on the server computer with a first display frame and a second display frame immediately adjacent said first display frame, wherein the first display frame comprises a page of the website;

(b) marking the page displayed in the first display frame with a first identifier and creating an interface call to a report server;

(c) retrieving a report file corresponding to the first identifier from the report server;

(d) displaying the analytics in the report file in the second display frame;

(e) after a pre-determined period of time, comparing the page displayed in the first display frame with the first identifier; and

(f) if different, repeating the method from step (b) for the page displayed in the first display frame; or

(g) if the same, resetting for a second of the pre-determined period of time and repeating the method from step (e).

In another aspect of the invention, the method is carried out by a module launched from a reporting program resident on the server computer.

In another aspect of the invention, the method is carried out by a module launched from a reporting program resident on the report server.

In another aspect of the invention, the step of marking the web page and creating the interface call is carried out by an initializing file.

In another aspect of the invention, there is provided a computer software product for configuring a computer to display analytics about a website resident on a server computer. The computer software product comprises a recording medium and means recorded on the recording medium for configuring the computer to perform the steps of:

(a) launching an analytics module;

(b) causing a browser program to be opened on the server computer with a first display frame and a second display frame immediately adjacent said first display frame, wherein the first display frame comprises a page of the website;

(c) marking the page displayed in the first display frame with a first identifier and creating an interface call to a report server;

(d) retrieving a report file corresponding to the first identifier from the report server;

(e) displaying the analytics in the report file in the second display frame;

(f) after a pre-determined period of time, comparing a page identifier of the page displayed in the first display frame with the first identifier; and

(g) if different, repeating the method from step (c) for the page displayed in the first display frame in order to update the report to match the page currently displayed; or

(h) if the same, resetting for a second of the pre-determined period of time and repeating the method from step (f) until the page identifier differs from the first identifier.

In another aspect of the invention, the computer software product comprises an initializing file to carry out the steps of marking the web page and creating the interface call.

### BRIEF DESCRIPTION OF THE DRAWINGS

These and other advantages of the invention will become apparent upon reading the following detailed description and upon referring to the drawings in which:

FIGS. 1 and 2 are each a graphic representation of a browser window launched by the present invention, and comprised of the frames as contemplated by the present invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description, similar features in the drawings have been given similar reference numerals.

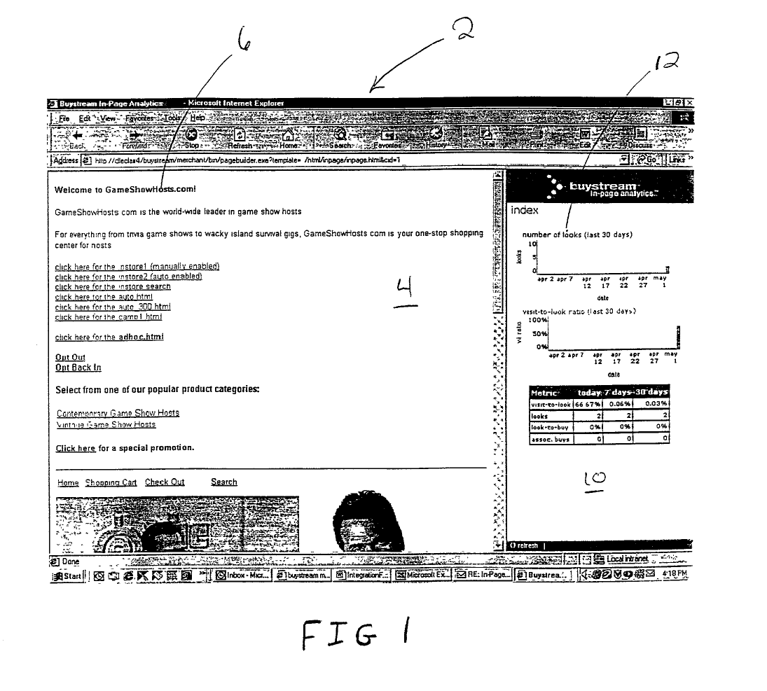

Turning to the drawings, FIG. 1 illustrates a standard Internet browser program screen 2, such as is typical with Microsoft Internet Explorer (TM) or Netscape (TM). The screen 2 is shown with two display frames. A first display frame 4 shows the content of a page 6 of a website, while the second display frame 10 shows a graphical report 12 of analytics about the page 6. Although the frames 4, 10 are illustrated next to each other, any arrangement whereby the frames are immediately adjacent one another within the browser screen would be acceptable.

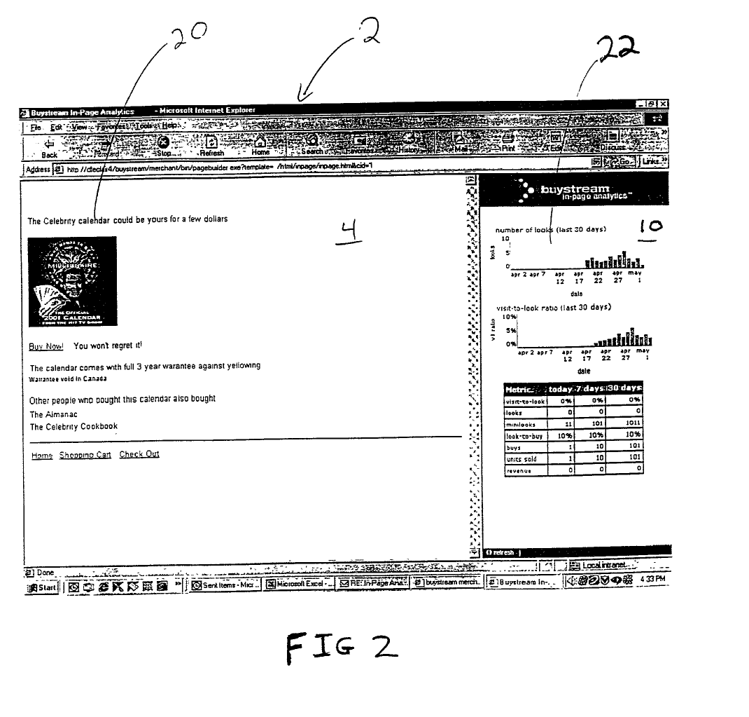

Similarly, FIG. 2 shows a browser screen 2 with two frames 4, 10. In this illustration the page 20 displayed in frame 4 is a different page from the website than the page 6 shown in FIG. 1. Consequently, the report 22 in FIG. 2 differs from the report 12 shown in FIG. 1.

FIGS. 1 and 2 illustrate the output of the software product of the present invention, and the display caused by the method, both of which will be discussed in more detail below.

The present invention relates to the display of web page related information, in either graphical or table format, in a browser frame while another frame on the screen displays the web page about which the report has been created. The website, comprising the web pages is typically resident on a server computer. The frames are displayed adjacent one another so that the report about the web page is available with the web page itself, thus allowing the user to conveniently and efficiently review the reports in parallel with the pages of the website.

The information or analytics can be gathered by traditional methods, such as counters which record the number of visits to a web page, or may come from metrics gathered or derived about the website from a reporting program or service. Such metrics may include information about the technical specifications of the visitors to the website Such gathered metrics about the visitor's technical specifications may include screen resolution, color depth, language preference, bandwidth settings and actual page download times. These and other metrics which form the report 12,22 may originate with applicant's proprietary method and system for gathering information about the technical specifications of a visitor to a web site, as disclosed in co-pending application Ser. No. 09/453,178, the specification of which is incorporated herein by reference. The reports displayed in the present invention need not be limited to reports generated by the applicant's co-pending method and system, however. Such methods include, but are not limited to: server log analysis; packet sniffing; data tag technology; database tags; application tags; and surveys.

Basic metrics that can be displayed within the report include, but are not limited to the following:

number of unique visitors to the web page;

number of visits to the web page;

number of page views (or looks);

number of times a visitor to the page buys something from the page;

number of units sold;

sales revenue (immediate, delayed, lifetime), per page or product;

ad revenue, per page;

subscription revenue, per page;

pay-per-view revenue;

download revenue, per page;

cost of content, per page;

content return on investment (“ROI”);

promotion revenue, per page;

promotion views;

promotion ROI;

attrition rates or numbers (for pages that are part of an identified linear path);

time per visit on page/site section/site;

time to checkout;

shopping cart usage;

search engine usage;

checkout page usage;

number of subscriptions;

number of log-ins;

number of registrations;

number of game uses;

number of application forms submitted; and

number of errors (html or network, partitioned according to type).

A number of derived metrics can be calculated from the basic metrics in the list above. These include, but are not limited to, the following:

any metric derived from taking ratios, or other simple calculations, of basic metrics. Examples are: visit-to-buy ratio, revenue per visit, lifetime revenue per visitor, and shopping cart abandonment ratio;

any metric arising as a projection or prediction of a basic or derived metric based upon historical values. An example might be customer churn likelihood over the next six months;

any metric arising from segmenting either basic or derived metrics according to visitor attributes such as, but not limited to: number of previous visits, number of previous buys, language, time zone, technology attributes, age, gender, geography such as country, state/province, city, zip code, income, education, interest profiles, marketing campaign (that delivered the visitor), previous purchase history, and lifetime customer value;

any metric indicative of the rate of change of any other metric. An example would be the monthly increase in visit numbers, expressed as a percentage, or quarter over quarter revenue change; and

any metric that is an aggregation of other more granular measures. An example would be presentation of revenue for a product line that is the sum of individual revenue values for all of the products that make up that line. That way, alongside an entrance page for the product line section of the web site, the user might see not only report items describing traffic levels for that individual page, but also aggregate information about the entire product line, because the product line entrance page would be an intuitive place to find that sort of summary information.

Preferably, the user will be able to tailor the analytics displayed to the page of the website under consideration. For example, the user or website owner may be interested in the number of visitors and repeat visitors to the home page of the site, but may be more interested in the sales of a specific product from another page in the site. Thus, the report may be customized to best suit the content of the page, and the needs of the user.

The method for displaying the information preferably is carried out by a software program and the steps may be described as follows:

1. An end-user, namely the website or business owner, or any other party wishing to review statistical information about the website launches an analytics module, either from within another web-based reporting product (such as that described in applicant's co-pending application Ser. No. 09/453,178) or as a standalone application.

2. A web-browser program is opened with two display frames immediately adjacent each other. The method is independent of the web browser program opened, but as noted in applicant's co-pending application Ser. No. 09/453,178, differences between INTERNET EXPLORER (tm) and NETSCAPE (tm) may result in differences in the way the information is gathered. Preferably, however, it should not affect the manner in which the report is to be displayed.

3. The first display frame opens up the home or first page of the web site to be examined. The home page URL would be configured, for this instance of the program and method, during initial installation of the program.

4. The second display frame opens up an initializing file, preferably written as an html file.

5. Software code, such as Javascript (tm) code within the initializing file first writes an identifier for the page (either the URL or a custom page ID) to a tag or cookie in the user's browser program which has been opened by the program's method, in step 1.

6. Software code, again such as Javascript (tm) code within the initializing file then makes a common gateway interface (“CGI”) call to a report server. This CGI call contains parameters that include the page identifier (either URL or page ID). The report server is the web-enabled server which hosts the data corresponding to the website under examination. It then creates the reports for viewing by the user. The report server may be the web site server computer itself, or it may be a stand-alone server dedicated exclusively to storage of web site related data and metrics and generation of website information and analytics reports.

7. The CGI program returns a report file, again preferably written in html, which consists of a set of graphs and/or tables that correspond to the page the ID of which was passed in step 6. The report file writes the report to the second display frame. In this manner, as shown in FIGS. 1 and 2, the required data and analytics about the desired web page, shown in the first frame, appear in the second frame, immediately adjacent that web page. The data used to construct these graphs and tables is resident in the report server to which the CGI call was made. This data is indexed by the page identifier (either URL or page ID). Since the browser operates in frames, report content in the second frame may be displayed in more than one format. For example, if the report file for the page contains several pages of information, the user can work in the second frame, viewing the various pages of information as required, without altering the view in the first page. In addition, a further report, or a different manner of presenting the report can be retrieved by selecting an optional feature in the program which will launch a new browser program window containing the further report or different representation of the report.

8. The report file calls a first function that sets a timer on its frame. The timer is calibrated at a relatively short pre-determined period of time (from 1/10 of a second to 1 second, preferably about ½ second).

9. Once the timer runs out, a second software code function reads the page identifier (either URL or page ID) of the page shown in the first display frame and compares it to the page identifier (URL or page ID) stored in the user's cookie. If the two values don't match, then the next step is initiated, namely the report items are replaced with new ones because the user has moved to a new page within the website. If the values match, then the timer is reset for a further of the pre-determined period of time (step 8) because the user is still looking at the same page of the website.

10. The report file reloads itself within the second display frame, passing the new page identifier (URL or page ID) to the CGI program. The method then returns to step 7.

This method can be carried out until the user terminates the session.

The method will operate essentially independently of the design of the website itself. Thus, for example, if the site is already frame based, the program of the present invention will recognize that and simply replicate the website's frames within the first display frame of the browser program window launched by the method. In the event that the web site automatically launches a new browser for a page or hyperlink selected by a visitor (for example for each different SKU), then it is contemplated that a further version of the program will be launched with the new browser in order to show the report for that page. The steps carried out to retrieve and display the information in the report file remain the same, however.

Thus, it is apparent that there has been provided in accordance with the invention a method and system for displaying analytics about a website or its contents that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

The embodiments of the invention in which an exclusive property or privilege is claimed are defined as follows:what I/we claim as my/our invention:

1. A method of displaying analytics about a website resident on a server computer, said method comprising the steps of:
(a) causing a browser program to be opened on said server computer with a first display frame and a second display frame immediately adjacent said first display frame, wherein said first display frame comprises a page of the website;
(b) marking the page displayed in said first display frame with a first identifier and creating an interface call to a report server;
(c) retrieving a report file corresponding to said first identifier from said report server;
(d) displaying the analytics in said report file in said second display frame; and
(e) after a pre-determined period of time, comparing the page displayed in said first display frame with said first identifier and, (f) if different, repeating the method from step (b) for said page displayed in said first display frame, or (g) if the same, resetting for a second of said pre-determined period of time and repeating the method from step (e).

2. The method of claim 1 wherein said analytics are gathered from technical specifications of visitors to the website.

3. The method of claim 1 wherein said analytics are derived from technical specifications of visitors to the website.

4. The method of claim 1 wherein said steps are carried out by a module launched from a reporting program resident on said server computer.

5. The method of claim 1 wherein said steps are carried out by a module launched from a reporting program resident on said report server.

6. The method of claim 1 wherein step b is carried out by starting an initializing file configured to tag the page displayed in said first display frame with said first identifier and create said interface call to said report server.

7. A computer software product for configuring a computer to display analytics about a website resident on a server computer, the computer software product comprising a recording medium; and means recorded on the recording medium for configuring the computer to perform the steps of:
(a) launching an analytics module;
(b) causing a browser program to be opened on said server computer with a first display frame and a second display frame immediately adjacent said first display frame, wherein said first display frame comprises a reproduction of a page of the website;
(c) marking the page displayed in said first display frame with a first identifier and creating an interface call to a report server;
(d) retrieving a report file corresponding to said first identifier from said report server;
(e) displaying the analytics in said report file in said second display frame;
(f) after a pre-determined period of time, comparing a page identifier of the page displayed in said first display frame with said first identifier; and
(g) if different, repeating the method from step (c) for said page displayed in said first display frame in order to update the report to match the page currently displayed; or
(h) if the same, resetting for a second if said pre-determined period of time and repeating the method from step (f) until the page identifier differs from the first identifier.

8. The computer software product of claim 7 wherein module is launched from a reporting program resident on the report server.

9. The computer software product of claim 7 wherein the module is launched from a reporting program resident on the server computer.

10. The computer software program of claim 7 further comprising an initializing file configured to tag the page displayed in said first display frame with said first identifier and create said interface call to said report server

11. The computer software product of claim 7 wherein said identifier is a cookie stored in the browser program.

12. The computer software product of claim 10 wherein the initializing file is an HTML file.

13. The computer software product of claim 7 wherein the analytics are displayed in graphical format.

14. The computer software product of claim 7 wherein the analytics are displayed in tabular format.

15. The computer software product of claim 7 wherein said pre-determined time is in the range of 0.1 seconds to 1 second.

16. The computer software product of claim 15 wherein said pre-determined time is preferably about 0.5 seconds.

17. The computer software product of claim 7 wherein the report server and the server computer are the same.

18. The computer software product of claim 7 wherein the interface call is carried out by a common gateway interface script.

19. The computer software product of claim 7 wherein the page identifier is the uniform resource locator of the web page.

20. The computer software product of claim 7 wherein the page identifier is a unique identification label assigned to the web page.
